(19) United States
(12) Patent Application Publication
(10) Pub. No.: US 2024/0065387 A1
(43) Pub. Date: Feb. 29, 2024

(54) TRANSVERSE MAGNETIC FASTENER

(71) Applicants: Patrick Kessler, San Francisco, CA (US); Anthony Ashcroft, San Francisco, CA (US); Jeremy Bataillou, San Francisco, CA (US); Eugene Whang, San Francisco, CA (US)

(72) Inventors: Patrick Kessler, San Francisco, CA (US); Anthony Ashcroft, San Francisco, CA (US); Jeremy Bataillou, San Francisco, CA (US); Eugene Whang, San Francisco, CA (US)

(21) Appl. No.: 18/241,100

(22) Filed: Aug. 31, 2023

Related U.S. Application Data
(60) Provisional application No. 63/402,836, filed on Aug. 31, 2022.

(51) Int. Cl. A44B 1/08

(52) U.S. Cl. CPC A44B 1/08; A44D 2203/00

(57) ABSTRACT

Embodiments described herein take the form of a fastener, such as a button, clasp, or the like, that magnetically attracts a button to an enclosure, thereby securely closing the fastener. In one example embodiment, the fastener includes a base and a ring. The ring defines an aperture and the base includes a button. The button can move perpendicularly to a surface of the base that abuts or otherwise engages the ring. The ring includes multiple magnets typically positioned within a body of the ring and, generally, at opposing positions along a circumference or perimeter of the ring. Similarly, a magnet is positioned within the button. As the ring approaches the base, the ring magnets attract the button magnet, drawing it into the ring and closing or securing the fastener. The button moves transversely to the polarization direction of the ring magnets (and button magnet) as the button extends.

### CROSS-REFERENCE TO RELATED APPLICATION(S)

This application is a nonprovisional patent application of and claims the benefit under 35 U.S.C. § 119(e) of U.S. Provisional Patent Application No. 63/402,836, filed Aug. 31, 2022, and titled “TRANSVERSE MAGNETIC FASTENER”, the contents of which are incorporated herein by reference in its entirety.

### FIELD

The described embodiments relate generally to fasteners. More particularly, the present embodiments relate to a magnetic fastener in which a button or clasp moves transversely to a direction of magnetic polarization within the button or clasp.

### BACKGROUND

Fasteners are used to attach one item to another. Most fasteners are mechanical; they rely on an interlock, friction, or physical alignment between two pieces to operate. Some fasteners are magnetic. Generally, these magnetic fasteners use a magnetic field to attract two pieces to one another and the force required to decouple the pieces depends on the magnetic field. Further, magnetic fasteners typically require a user to pull against the force arising from the magnetic field to decouple the fastener.

### SUMMARY

Certain embodiments described herein take the form of a fastener, such as a button, clasp, or the like, that magnetically attracts a button to an enclosure, thereby securely closing the fastener. In one example embodiment, the fastener includes a base and a ring. The ring defines an aperture and the base includes a button. The button can move perpendicularly to a surface of the base that abuts or otherwise engages the ring (an “engagement surface”). The ring includes multiple magnets typically positioned within a body of the ring and, generally, at opposing positions along a circumference or perimeter of the ring. Similarly, a magnet is positioned within the button. As the ring approaches the base, the ring magnets attract the button magnet, drawing it into the ring and closing or securing the fastener. The button moves transversely to the polarization direction of the ring magnets (and button magnet) as the button extends into the ring.

One embodiment takes the form of a fastener, comprising: a base; a button at least partially retained within the base; and a ring defining an aperture sized to accept at least a portion of the button; wherein: the button is moved from an undeployed position to a deployed position by a magnetic field; and a motion of the button is transverse to the magnetic polarization direction.

Another embodiment takes the form of a fastener, comprising: a base comprising: a base; and a biasing mechanism attached to the base; a button retained at least partially within the base and comprising: a button cap; and a button magnet attached to the button cap; and a ring defining an aperture and comprising: a ring; and a set of ring magnets attached to the ring; wherein: a magnetic field extends between the ring magnets of the set of ring magnets; the magnetic field attracts the button magnet when the base abuts the ring; the magnetic field moves the button from an undeployed position to a deployed position when the magnetic field attracts the button magnet; and as the button moves from the undeployed position to the deployed position, it moves in a direction other than the polarization direction of the magnets.

Still another embodiment takes the form of a method for fastening a fastener, comprising: moving a ring of the fastener adjacent to a base of the fastener; magnetically attracting a button of the fastener to the ring, thereby moving the button relative to the ring; and receiving the button within an aperture defined in the ring; wherein: the magnetic field extends in a first direction; and the button moves in a direction transverse to the polarization direction of the magnets.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 shows a first view of an example fastener in an uncoupled position.

FIG. 2 shows a second view of the example fastener of FIG. 1 in a coupled position.

FIG. 3A is a cross-sectional view of an example fastener in an uncoupled position.

FIG. 3B is a cross-sectional view of the example fastener of FIG. 3 in a coupled position.

FIG. 4 is a top view of the magnets of an example fastener.

FIG. 5 is another cross-sectional view of an example fastener.

FIG. 6 is an exploded view of an example fastener.

FIG. 7 is a flowchart illustrating a sample method for affixing a fastener to a material.

FIG. 8 shows a sample top tool for use in the method of FIG. 7.

FIG. 9 shows a sample base tool for use in the method of FIG. 7.

### DETAILED DESCRIPTION

Certain embodiments described herein take the form of a fastener, such as a button, clasp, or the like, that magnetically attracts a button to an enclosure, thereby securely closing the fastener. In one example embodiment, the fastener includes a base and a ring. The ring defines an aperture and the base includes a button. The button can move perpendicularly to a surface of the base that abuts or otherwise engages the ring (an “engagement surface”). The ring includes multiple magnets typically positioned within a body of the ring and, generally, at opposing positions along a circumference or perimeter of the ring. Similarly, a magnet is positioned within the button.

In operation the ring may sit atop, or otherwise abut, the base although the ring and base are fully separable from one another. When the ring abuts the base the magnets in the ring attract the magnet in the button, causing the button to extend from the base into the ring. The aperture of the ring is sized to receive the button, such that the button's motion positions the button within the aperture.

Once the button is received within the aperture and held in place by the ring and button magnets, the fastener resists lateral forces and thus lateral decoupling. A “lateral force” is a force that attempts to move the ring perpendicular to its cylindrical axis. The button constrains such motion as it impacts a sidewall defining the aperture. Purely lateral forces thus would break the fastener before decoupling the base from the ring.

By contrast, the fastener can be relatively easily decoupled in multiple ways. First, the fastener can be decoupled by depressing the button, thus removing it from the aperture, and applying a lateral force to slide the ring relative to the base or vice versa. Alternatively, an axial force (e.g., a force in the direction of the cylindrical axis of the ring) of sufficient strength to overcome the attractive force between the ring magnets and the button magnet will separate the fastener. This is true whether or not the button is depressed, although the magnitude of the axial force necessary to separate the fastener is reduced when the button is depressed and retracted into the base. When the button is in the base as opposed to in the aperture, the ring magnets are farther away from the button magnet and so the attractive force between the ring and the base is lower.

As the button moves from a coupled to a decoupled position, the force necessary to cause this motion falls off rapidly before rising again when the button reaches its end of travel. This provides pleasant haptic feedback to a user indicating that the button has been fully depressed, and that the fastener may now be opened with a lateral force. This tactile feedback is markedly different from the harsh and abrupt clicking or snapping feeling of many fasteners as they open.

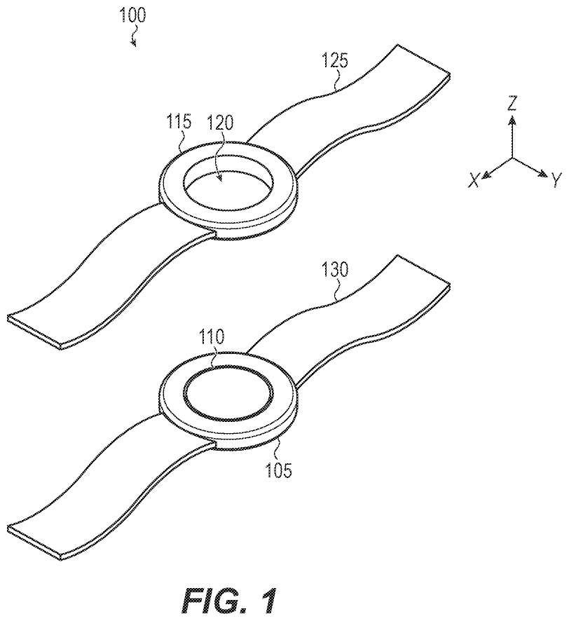

FIG. 1 illustrates an example fastener 100 in an open or uncoupled position. In this example the fastener 100 is formed from a ring 115, base 105, and button 110 attached to the base. While both the ring and base are shown connected to band 125, 130s, other embodiments may omit the bands. As an example, the ring and base may be connected to sheet bodies instead. The ring 115 and base 110 may be affixed to fabric, plastic, metal, wood, composites, or any suitable surface. Similarly, the ring 115, button 110, and/or base 105 may be formed from any material that permits a magnetic field to pass from one or more magnets in the ring into one or more magnets in the button, and vice versa.

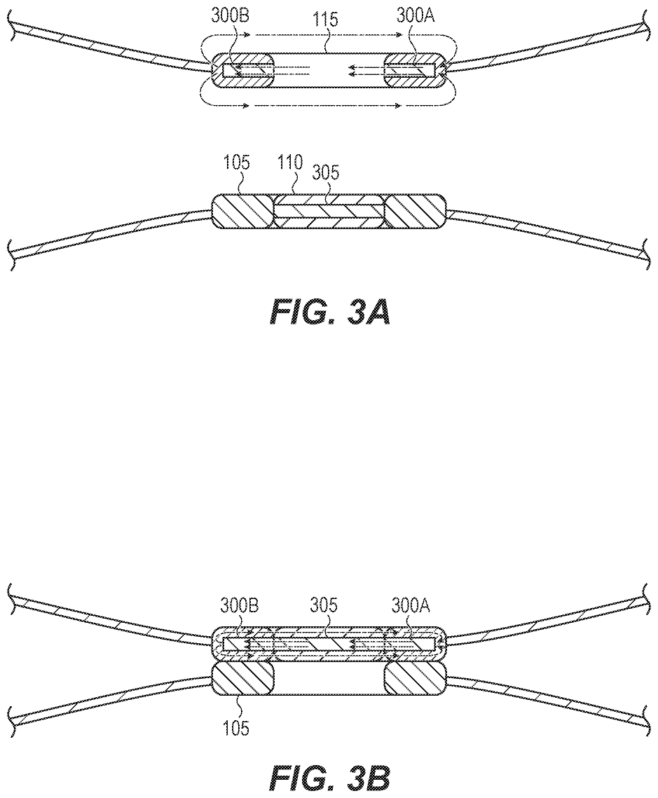

The ring 115 defines an aperture 120 in its interior. The aperture 120 may pass through an entirety of the ring 115 (e.g., be a void space defined by one or more sidewalls and that opens through opposing surfaces of the ring) or may pass partially through the ring (e.g., be a void space defined by one or more sidewalls, one of which may form a bottom or top of the aperture). In many embodiments, the aperture 120 is sized to receive the button 110. Generally, the aperture is slightly larger in its length and width than the button such that the button fits snugly within the aperture. A height of the aperture 120 may be approximately the same as a height of the button 110 above the base 105 when the button extends, as described below, or may be greater or less than such a height. As used herein, “length” refers to a measurement along an X axis of the ring and/or base, “width” refers to a measurement along a Y axis of the ring and/or base, and “height” refers to a measurement along a Z axis of the ring and/or base. For ease of reference, a corresponding set of axes is shown in FIG. 1. The motion of the button 110 is transverse to the polarization direction of the ring magnets (shown and described below with respect to FIGS. 3A-3B).

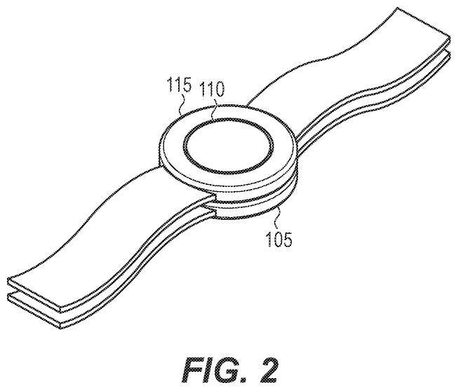

The button 110 may move into and partially out of the base 105 along the Z-axis, as discussed in more detail below, FIG. 2 shows the fastener 100 of FIG. 1 with the button 110 extended (e.g., having moved out of the base 105). When the button 110 is in the position shown in FIG. 2, it is received in the aperture of the ring 115 when the ring overlies the base 105, thus preventing the base and ring from separating in response to a lateral force. Perpendicular (Z-axis) motion of the button 110 is discussed in more detail below.

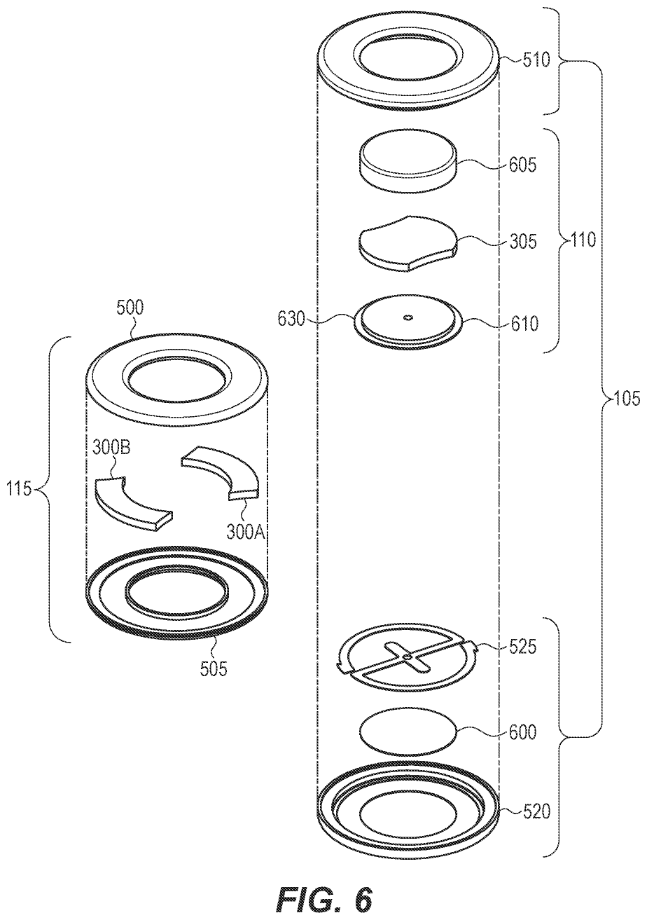

FIG. 3A is a vertical cross-sectional, schematic view of the fastener of FIG. 1 taken when the fastener 100 is in the open or decoupled position. FIG. 3A omits certain features that are discussed below with respect to FIG. 6 for simplicity of illustration. As shown in this cross-sectional view, there is a magnet or magnets 300A, 300B in a body of the ring (a “ring magnet”) as well as a magnet or magnets 305 in the button (a “button magnet”). The ring magnets 300A and 300B have the same magnetic polarization vector. This vector is radial with respect to the ring.

Initially, when the ring 115 and base 105 do not abut (e.g., contact) one another, the ring magnets 300A, 300B establish a magnetic field as shown in FIG. 3A. It should be noted that the magnetic field may extend above or below upper and lower surfaces of the ring 115 to varying degrees, depending on the strength, shape, and material of the ring magnets and the ring. Due to the air gap in the aperture 120, this magnetic field has relatively weak flux.

However, the magnetic flux is sufficiently strong to attract the button magnet 305 as the base 105 moves closer to, and ultimately abuts, the ring 115. The magnetic field's flux may overcome a biasing force that keeps the button 110 in its unextended (e.g., undeployed) position within the base 105, thereby drawing the button into an extended (e.g., deployed) position in which it partially protrudes from the base and into the aperture as illustrated in FIG. 3B. Thus, the magnetic field moves the button 110 transversely to the polarization direction of the magnets.

When the button 110 extends into the aperture 120, the button engages the ring 115 and prevents decoupling of the ring 115 from the base 105 by resisting lateral forces. Similarly and as shown in FIG. 3B, the force of magnetic attraction between the ring magnets 300A, 300B and button magnet(s) 305 holds the button 110, and thus the base 105, in place relative to the ring 115. The magnetic force therefore resists axial decoupling of the ring and base. FIG. 3B omits certain features that are discussed below with respect to FIG. 6 for simplicity of illustration.

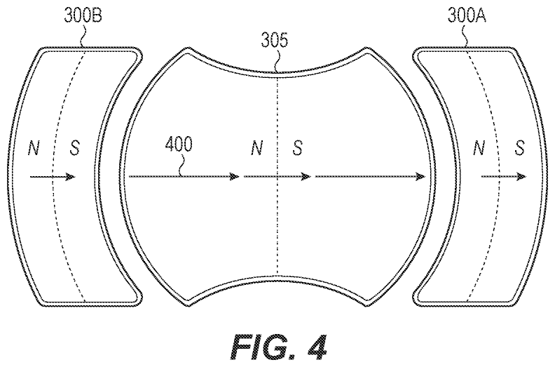

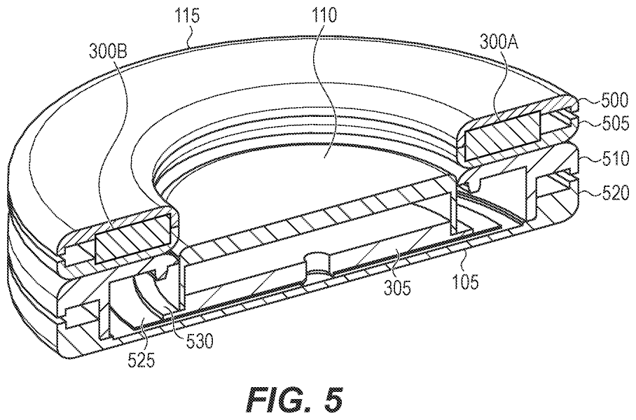

FIG. 4 is a lateral view of the fastener 100 taken at a 90-degree angle from the vertical cross-section shown in FIG. 3B, showing only the relative positions of the ring magnets 300A, 300B and button magnet 305 when the button is deployed. FIG. 3B omits certain features that are discussed below with respect to FIG. 5 for simplicity of illustration. Again in this figure, the ring and base abut and are coupled to one another by magnetic attraction between the ring magnets and button magnet. As shown, a direction of the magnetic field 400 created by the positioning of the ring magnets and button magnet extends along a length (or, in some embodiments, width) of the ring magnets 300A, 300B and button magnet 305 and transversely or perpendicularly to a height of the button and ring.

As can be seen, the polarization of the magnets 300A, 300B, 305 (and thus the direction of the magnetic field 400 through a center of the magnets) is transverse to the direction of motion of the button. That is, the polarization of the magnets and direction of the resulting magnetic field is lateral while the button moves perpendicularly, such that the two are at right angles to one another. The magnetic field causes the button to move into the field (e.g., into the aperture and between the ring magnets) rather than along the magnetic field. This leads to a compact design for the fastener as the ring and its aperture need not be sized to permit the button to move within it or along the magnetic field.

In certain embodiments the magnets may be shaped to fit within the ring and/or button. Likewise, the magnets may be shaped to constrain or guide a resulting magnetic field. For example, the ring magnets 300A, 300B are both semicircular and sized to fit within the ring. Similarly, the sidewalls 310A, 310B of the button magnet 305 that face the ring magnets 300A, 300B are outwardly scalloped to contour to a shape of the button while sidewalls 315A, 315B normal to the ring magnets are inwardly scalloped. These inwardly-scalloped sidewalls 315A, 315B shape and constrain the magnetic field 400, generally reducing how far the field expands beyond the button in a direction normal to the field line shown and normal to a direction of motion of the button (e.g., up and down with respect to the view of FIG. 4).

A user may decouple the base 105 from the ring 115 by pressing the button 110 downward, into the base and to its initial, decoupled position as shown in FIG. 1. Because of other forces acting on the button, it is relatively easy to press the button 110 and disengage the base 105 from the ring 115. As the button moves downward towards and/or into the base, the amount of force necessary to lift the ring from the base decreases. Alternatively, a user may grasp the ring 115 or item attached to the ring and pull away from the base 105. Presuming the base 105 is constrained in its movement while the ring 115 is relatively free to move away from the base, the ring and base will separate once the user applies sufficient force to overcome the attractive force of the magnetic field passing through the ring and button magnets.

The base 105 may include a biasing mechanism to retain the button 110 in its decoupled position regardless of an orientation of the button and base. For example, the biasing mechanism may retain the button 110 at least partially within the base 105 if the base is flipped over, jostled, or the like. Further and as shown in FIGS. 1, 3A, and 5, the upper surface of the button 110 may be substantially flush with the upper surface of the base 105 when the button is in the decoupled position.

FIG. 5 is a cross-sectional view of the ring 115, button 110, and base 105. As shown in this figure, the ring 115 may be formed from a ring upper shell 500 attached to a ring lower shell 505. The ring upper shell 505 and ring lower shell 510 define an interior space within the ring 115, in which the ring magnets 300A, 300B are positioned. The ring magnets 300A, 300B may be affixed to either or both of the ring upper shell 500 and ring lower shell 505.

Likewise, the base 105 is formed from a base upper shell 510 attached to a base lower shell 520, which define an interior space within the base. A flange 530 of the button is received within this interior space; the flange 530 cannot move past the base upper shell 510, thereby limiting the button's vertical motion and ensuring the button 110 does not separate from the base 105 when moving into the aperture of the ring 115.

FIG. 5 illustrates a sample biasing mechanism within the base. Here, the biasing mechanism is a spring 525 exerting a restoring force on the flange 530 of the button 110 retained within the base. The spring 525 exerts force on a lower surface of the button flange 530, pulling the button 110 into the base (e.g., into a decoupled position). The spring force is typically less than the attractive force exerted on the button magnet 305 by the ring magnets 300A, 300B, thereby allowing the button 110 to extend from the base 105, into the aperture 120, and expanding the spring 525 when the ring abuts the base as described above. The spring (or other biasing mechanism) therefore not only retracts the button when the ring is removed from the base but also maintains the button in its decoupled position relative to the base. In some embodiments the spring may compress when the button extends and expand to return the button to its undeployed position.

Not all embodiments use a spring 525 as a biasing mechanism. In another sample embodiment, the biasing mechanism is a magnet positioned beneath the button 110. This biasing magnet attracts the button magnet 305, again holding the button 110 in its decoupled position relative to the base 105. The force arising from the biasing magnet is typically weaker than the force arising from the ring magnets 300A, 300B. Put another way, when the ring abuts the base, the button magnet is more attracted to the ring magnets than the biasing magnet. This results in the button 110 moving perpendicularly to the base 105 and extending into the aperture 120, thereby coupling the ring 115 to the base 105 and fastening the fastener 100. As the ring is pulled away from the base or the button is depressed by the user, the biasing magnet attracts the button and holds it in its undeployed position. Further, and as shown in the exploded view of FIG. 6 (discussed below), certain embodiments may use multiple biasing mechanisms, such as both a spring and return magnet.

Additionally, in many embodiments the spring 525 may center the button relative to the base. By maintaining a position of the button with respect to the base, the spring ensures that the button is not off-center within the base. When the ring is aligned with the base, the button is likewise centered with respect to the ring and so extends into the aperture without impacting a sidewall of the aperture. Further, since the spring centers the button within the base and maintains the relative positions, a gap may be defined between the button and base without concern that the button will shift or slide. This gap permits the button to operate (e.g., extend and retract or decouple) without being bound or restricted by the button.

Some embodiments may include rotational freedom, but with a restoring torque provided by magnets 300A, 300B, and 305 which cause the ring to snap to its correct rotational position with respect to the base. Still other embodiments may incorporate one or more orientation magnets within the base. These orientation magnets generally have opposite polarities to the ring magnets, such that the ring magnets are attracted to the base. The orientation magnets may hold the ring in a specific position and/or orientation relative to the base, for example ensuring that the aperture of the ring does not overlap the base (which, in turn, would prevent the button from deploying). In some embodiments, the ring includes a single set of ring magnets that are both attracted to the orientation magnets and which attract the button magnet to deploy it, as described above. In other embodiments, the ring may include a first set of ring magnets to attract the button magnet and a second set of magnets to attract the orientation magnets. In either configuration the magnetic force and field between the orientation magnet and any ring magnet is less than the magnetic force and field between the button magnet and a respective ring magnet. This ensures the orientation magnets do not provide additional substantive resistance to vertical decoupling of the ring from the base.

In yet other embodiments the ring may be fully or partially rotatable. Further, the ring may so rotate relative to the base while the ring and base are coupled to one another. By rotating the ring 180 degrees relative to the base while the two are coupled, and with the button rotatably fixed, the ring magnets likewise rotate so that their polarization opposes that of the button magnet. This causes the ring magnets to repel the button magnet rather than attract it, thereby forcing the button magnet and associated button downward from its deployed position to its undeployed position. The entire base is forced away from the ring as well. This is yet another mechanism that may be used by an embodiment to decouple or open the fastener. In other embodiments, the button or base may rotate relative to the ring to achieve the same effect. If the button is not rotatably fixed, then rotating the ring will not open the fastener, which might be desirable in certain embodiments.

FIG. 6 is an exploded view of a sample embodiment of the fastener. The ring is formed from a ring upper shell 500 attached to a ring lower shell 505. Two ring magnets 300A, 300B are sandwiched between the upper and lower shells 500, 505. The ring magnets 300A, 300B are attached to one or both of the ring upper shell 500 and ring lower shell 505. In some embodiments, the ring upper shell 500 is fixedly attached to the ring lower shell 505 to form the ring 115 while, in other embodiments, the ring upper shell may rotate relative to the ring lower shell. In embodiments that permit such rotation, the ring magnets 300A, 300B are typically attached to the ring upper shell 500 and rotate with it to force an extended button 110 into an undeployed position, as described above.

The button 110 includes a button cover 605 attached to a button substrate 610. The button magnet 305 is fixed to one or both of the button cover 605 and button substrate 610. The button substrate 610 may define a flange 615 (similar to the flange 530 of FIG. 5). This flange 615 may extend outward uniformly as shown, may be notched, or otherwise may be discontinuous.

The base 105 includes a base upper shell 510 attached to a base lower shell 520, thereby forming the base. The base 105 contains a spring 525 and a biasing magnet 600. The spring 525 may be attached to, or partially retained in, the base lower shell 520 and is likewise attached to the button magnet 305 and/or the button substrate 610. A swaged flange, a screw, or similar connector (not shown) may pass through the spring 525 and button substrate 610 and into the button magnet 305, thereby connecting all three and holding them together. The biasing magnet 600 may be positioned in a recess defined in the base lower shell 520. The biasing magnet 525, in addition to (or instead of) assisting in returning the button 110 to its undeployed position as described above, may retain the button 110 in the undeployed position when the ring 115 is sufficiently separated from the base 105. The biasing magnet 600 magnetically attracts the button magnet 305, thereby retaining the button 110 relative to the base 105 in this scenario.

Additionally, the flange 530 of the button substrate 610 is retained within the base 105; the flange 530 is larger in diameter or dimension than the opening in the base upper shell 510. This prevents the button 110 from separating from or fully exiting the base 105 when the button extends.

The spring 525 generally resists expansion; the spring 525 expands as the button 105 moves away from the base lower shell 520. As the spring 525 is attached to the base lower shell 505 and the button magnet 305, it pulls the button magnet 305 toward the base lower shell 520. This force restores the button to its undeployed position. In embodiments using a biasing magnet 600 and/or biasing spring 525, the magnetic attraction between the ring magnets and the button magnet 305, when the ring 115 abuts the base, is great enough to overcome the restoring and/or retention force(s) of the spring 525 and/or magnet 600, whether alone or in combination, in order to deploy the button 605.

Certain embodiments may include a magnetic sensor, such as a magnetometer or Hall effect sensor. The sensor may be located within the ring, the base, a strap or fabric attached to either, or another element (such as an electronic device) nearby the fastener. The magnetic sensor may sense changes in the strength of the magnetic field between the ring magnets. For example, the magnetic field strength may increase when the button is deployed (since the button magnet is positioned between the ring magnets) and decrease when the button is undeployed (since an air gap, rather than the button magnet, is positioned between the ring magnets). By sensing changes in the magnetic field strength, the sensor may determine if the fastener is open or closed (e.g., whether the button is deployed or undeployed). The sensor, in turn, may transmit a signal to an associated electronic device in order to provide the fastener and/or button status to the device. This may be useful, for example, if the fastener is incorporated into a safety mechanism such as a door lock, seat belt, clip, harness, or the like. As one non-limiting example, the fastener may be incorporated into a retaining mechanism such as a seat belt in a car. The car may not start, may not move, or may be speed-limited unless the sensor senses that the retaining mechanism is fastened (e.g., the button or similar structure is received in the aperture of the ring or similar structure).

Although embodiments have been described as using magnets, it should be understood that those magnets may be either permanent magnets or electromagnets. Further, any suitable material may be used to form the ring magnets, button magnet, and/or biasing magnet and different magnets may be formed from different materials. As one non-limiting example, the biasing magnet may be made of iron (or another soft magnetic material) while the ring magnets are made of neodymium (or another hard magnetic material). This may be useful to ensure the ring magnets produce a stronger magnetic field than the base magnet to facilitate operation of the fastener, as described herein.

Yet other embodiments may utilize a fixed post in lieu of the button, in combination with an expanding or extending ring instead of a fixed ring. That is, the ring may extend to encircle a fixed post rather than the button extending to be received within the ring. Other shapes and configurations of the base, button/post, and/or ring are possible and within the spirit and scope of the present disclosure. Generally, such shapes, configurations, and embodiments include a movable element that moves toward a stationary element. Further, in such shapes, configurations, and embodiments the movable element translates in a direction transverse to the magnetic field established when the movable element engages the stationary element.

Still other embodiments may omit the button magnet entirely and instead form the button (or a portion thereof) out of a ferromagnetic material. For example, the button cover may be made from iron, cobalt, or the like. The button cover may thus be attracted to the ring magnets and thereby cause the button to deploy rather than relying on a button magnet.

It should be appreciated that the button may be static in certain embodiments. That is, there is no need for the button to deploy or undeploy; the button may permanently extend from the base. Such embodiments may be simpler to manufacture since there are no moving parts. The button and ring typically still contain their respective magnets and operation of the fastener remains the same in that a magnetic field generated by the ring magnets attracts the button magnet, and thus the button, into the ring aperture. The magnetic force of the field still holds the button and base in place with respect to the ring and resists decoupling along the cylindrical axis of the ring while the mechanical interlock between button and ring resists decoupling of the base and ring in the radial direction.

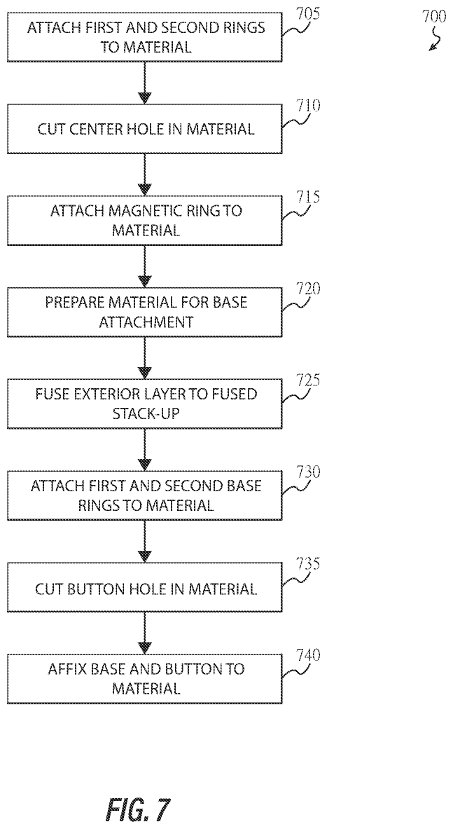

FIGS. 7-9 illustrate a sample method and related operations for attaching a base 105, button 110, and ring 115 of a fastener 100 to a material. The material may be any suitable structure, composition, device, layer, stack-up, item, or element. For example, the material may be a portion of an automobile door, chassis, interior surface, and so on. As yet another example, the material may be a container. As still another example, the material may be a garment and FIGS. 7-9 are described with respect to attaching a fastener 100 to two pieces of a garment.

FIG. 7 illustrates the method for attaching a fastener 100 to a material, which in this example is a garment. More particularly, the garment includes a first part and a second part designed to be fastened together, for example to close or secure the garment. The ring 115 is attached to the first part of the garment and the base 105 to the second part of the garment.

Initially, the method 700 begins in operation 705, where first and second nylon rings are attached to the first part of the garment. A ring tool, consisting of a ring tool top plate and a ring tool bottom plate, may press the nylon rings onto the first part of the garment, applying either or both of heat and pressure to adhere the nylon rings to the garment. As one non-limiting example, the ring tool may apply 3 MPa of pressure and 170 degrees Celsius heat to the nylon rings, although it should be understood that these values are non-limiting. Different pressures and/or heat may be used in different embodiments. Likewise, the rings need not be made of nylon but instead can be made of any suitable material that bonds to the material under sufficient heat and pressure.

Generally, a nylon ring is positioned on either side of the material, namely a first nylon ring below a top plate of the ring tool and a second nylon ring above a bottom plate of the ring tool. The ring top and bottom plates move towards one another, sandwiching the first part of the material between the first and second nylon ring. Openings may be cut in the material to allow alignment features or fiducials extending from the tool bottom plate to be received in apertures formed in the tool top plate, thereby ensuring the alignment of the bottom plate with respect to the top plate.

In operation 710, the ring tool cuts a center hole for mounting the ring 115 of the fastener 100. The ring bottom plate forms, includes, or is attached (whether removably or fixably) to a die cutter. The ring top and bottom plates are moved towards one another until the die cutter penetrates the material, forming the center hole. Typically, although not necessarily, operation 710 is done without application of any heat but sufficient pressure to allow the die cutter to penetrate the material. The aforementioned alignment features extending from the ring tool bottom plate again may be received in the apertures formed in the ring tool top plate, thereby ensuring alignment of the plates relative to one another. Generally, although again not necessarily, the portion of the material cut by the die cutter is within the nylon rings and the nylon rings themselves are not cut. In some embodiments a laser cutter is used instead of a die cutter to perform this operation.

Next, in operation 715, the magnetic ring 115 is attached to the nylon ring and/or material, such that, when the fastener is fastened, the button extends through the hole formed in the first part of the material and into the ring 115.

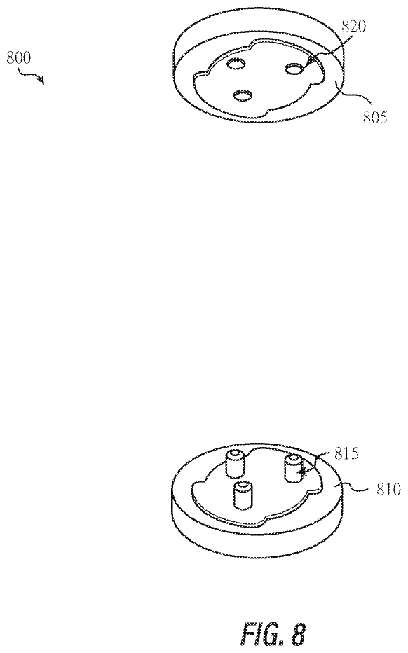

FIG. 8 shows a ring tool 800 including a ring tool top plate 805 and a ring tool bottom plate 810 configured to apply heat and pressure to first and second nylon rings, as described with respect to operation 705. This bonds the first and second nylon rings to the first part of the garment. As shown in the figure, the ring tool bottom plate 805 may include alignment features 815 that extend into apertures 820 in the ring tool top plate 800. These features may be omitted or reversed in other embodiments. The ring tool top plate 805 and ring tool bottom plate 810 are generally configured to perform operations 705-715, as described above. In some embodiments different versions of the ring tool may perform each such operation, while in others a single ring tool may perform them all. Further, certain elements of the ring tool may be swapped out between operations, such as adding a die cutter or the like.

Returning to FIG. 7, in operation 720 the second part of the material is prepared to be attached to the base, if necessary. It should be appreciated that operation 720 is optional and may be omitted, depending on the nature of the material. In this particular example of the method 700, the material is a garment, and more specifically a jacket with multiple layers including a down fill. A base adhesion tool compresses the layers (or some layers) of the down jacket in the second part of the material, applying heat and pressure for a time to fuse at least some layers together at the second part. For example, the base adhesion tool may fuse nylon layers to one another and/or through intervening layers such as a Vectran reinforcement layer or the like; in one example the base adhesion tool may heat the material to 170 degrees Celsius and apply a pressure of 0.475 MPa, for 15 seconds. This stabilizes the fusing and intermittent layers (if any) with respect to one another, thereby ensuring that later operations are performed on all such layers at the same time and without any layer shifting. Thus, operation 720 creates a fused stack-up from the second part of the material. As used with respect to FIG. 7, “fusing” portions, segments, or layers of a material together refers to bonding them to one another by applying heat and pressure.

Operation 725 follows, in which an exterior layer of the material may be fused or otherwise attached to the fused stack-up. The exterior layer may be, for example, a portion of a nylon shell. The base adhesion tool may again be used to fuse the exterior layer to the fused stack-up. As one non-limiting example, the base adhesion tool may apply 0.475 MPa of pressure at 170 degrees Celsius for 30 second to fuse the exterior nylon layer to the fused stack-up. This creates a finally-fused structure within or from the second part of the material.

Next, in operation 730, base rings are attached to the exterior surfaces of the finally-fused structure. A base ring tool aligns first and second base rings with respect to one another and the finally-fused structure. Here, the first and second base rings may be nylon but that is not required; any suitable material can be used.

The base ring tool may have a base ring top plate and base ring bottom plate, including alignment structures such as one or more posts and receptacles that ensure the base ring top plate and base ring bottom plate are properly aligned with respect to each other when the base ring tool operates. A set of holes can pass through the material (e.g., the fully-fused structure) to allow the posts to be received by the receptacles and to align the material with respect to the base tool.

Generally, the base ring top plate and base ring bottom plate are brought towards one another, sandwiching the first base ring, finally-fused structure, and second base ring between them. As with other operations described herein, the base ring tool applies heat and pressure to affix the first and second base rings to the fully-fused structure. The base ring top plate and base ring bottom plate typically include restraining features that prevent the first and second base rings from moving laterally with respect to the base tool. As one example, the base ring top and bottom plates may define a series of radially-extending protrusions that are received within radially-extending apertures defined in the base rings, thereby preventing or reducing lateral motion of the base rings.

The base ring top and bottom plates apply pressure to the first and second base rings to adhere or fuse them to the material, and particularly to the fully-fused structure. As one non-limiting example, the pressure may be 0.3 MPa while the temperature is 170 degrees Celsius, and both may be applied for 30 seconds. These values may vary with the composition of the first and second base rings, and/or the material.

In operation 735 a hole is cut through the material to permit the button to pass therethrough. This hole is generally defined within the area encompassed by the top and bottom base rings and, in some circumstances, may be cut through the base rings as well. This hole may be made using a die cutter or laser cutter.

Finally, in operation 740, the fastener base is affixed to the top and bottom nylon rings with the button secured therein and configured to extend through the hole created in operation 735 as well as the hole created in operation 710. This allows the button to extend from the base, through the second part of the material, through the first part of the material, and be received by the ring to fasten the garment, as described herein.

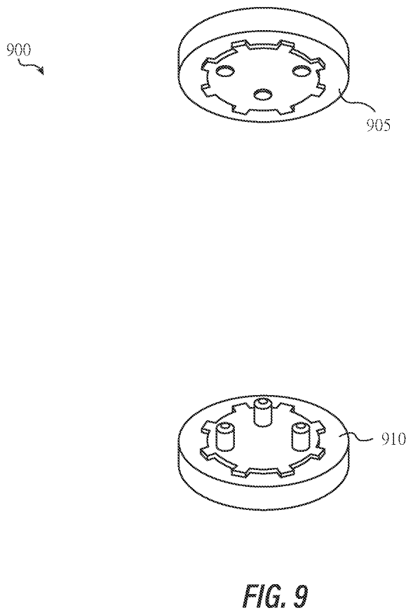

FIG. 9 illustrates one sample embodiment of a base ring tool configured to perform one or more of operations 720-740. The base ring tool 900 includes the base ring top plate 905 and base ring bottom plate 910. The base ring top and bottom plates 905, 910 may be reconfigured to perform various operations or may be configured to perform all operations without any change between operations. For example, a die cutter may be added to the base ring top plate 905 in certain embodiments while in others the die cutter may be an integral or constant part of that top plate 905.

Although embodiments have been described herein with respect to particular configurations and methods of operation, it should be understood that these embodiments, configurations, and methods are examples rather than limitations. Certain embodiments may be differently configured or operate in a different fashion while still falling within the spirit and scope of the disclosure. Accordingly, the proper scope of this invention is defined by the following claims rather than this specification.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not intended to be exhaustive or to limit the embodiments to the precise forms disclosed. It will be apparent to one of ordinary skill in the art that many modifications and variations are possible in view of the above teachings.

What is claimed is:

1. A fastener, comprising:
a base;
a button at least partially retained within the base; and
a ring defining an aperture sized to accept at least a portion of the button; wherein:
the button is moved from an undeployed position to a deployed position by a magnetic field; and
a motion of the button is transverse to the magnetic field.

2. The fastener of claim 1, further comprising:
a first ring magnet positioned within the ring;
a second ring magnet positioned within the ring; and
a button magnet positioned within the button; wherein:
the first ring magnet, second ring magnet, and button magnet generate the magnetic field; and
magnetic attraction between the first ring magnet, second ring magnet, and button magnet causes the button to move into the deployed position.

3. The fastener of claim 2, wherein the first and second ring magnets are positioned at opposing positions within the ring.

4. The fastener of claim 2, wherein a strength of the magnetic field increases when the button is in the deployed position.

5. The fastener of claim 4, further comprising a sensor configured to sense the strength of the magnetic field.

6. The fastener of claim 1, further comprising a biasing mechanism operable to move the button from the deployed position to the undeployed position by exerting a biasing force on the button.

7. The fastener of claim 1, wherein the biasing force is less than a magnetic force of the magnetic field.

8. A fastener, comprising:
a base comprising:
a base; and
a biasing mechanism attached to the base;
a button retained at least partially within the base and comprising:
a button cap; and
a button magnet attached to the button cap; and
a ring defining an aperture and comprising:
a ring; and
a set of ring magnets attached to the ring; wherein:
a magnetic field extends between the ring magnets of the set of ring magnets;
the magnetic field attracts the button magnet when the base abuts the ring;
the magnetic field moves the button from an undeployed position to a deployed position when the magnetic field attracts the button magnet; and
as the button moves from the undeployed position to the deployed position, it moves in a direction other than the polarization direction of the magnets.

9. The fastener of claim 8, wherein the button moves transversely to the polarization direction of the magnets.

10. The fastener of claim 8, wherein the biasing mechanism is a biasing magnet.

11. The fastener of claim 10, wherein:
the ring magnets are made of a hard magnetic material; and
the biasing magnet is made of a soft magnetic material.

12. The fastener of claim 8, wherein the button magnet defines first and second scalloped sidewalls opposing one another.

13. The fastener of claim 12, wherein the button magnet focuses the magnetic field when the button is in the deployed position.

14. The fastener of claim 8, wherein:
the biasing mechanism is a first biasing mechanism;
the fastener further comprises a second biasing mechanism attached to the base;
the first biasing mechanism is a spring; and
the second biasing mechanism is a magnet.

15. The fastener of claim 8, wherein the spring is further attached to the button magnet.

16. The fastener of claim 8, wherein the spring resists expansion as the button moves from the undeployed to the deployed position.

17. The fastener of claim 8, wherein:
the button further comprises a flange attached to the button cap; and
the flange is retained within the base as the button moves from the undeployed to the deployed position.

18. A method for fastening a fastener, comprising:
moving a ring of the fastener adjacent to a base of the fastener;
magnetically attracting a button of the fastener to the ring, thereby moving the button relative to the ring; and
receiving the button within an aperture defined in the ring; wherein:
the magnetic field extends in a first direction; and
the button moves in a direction transverse to the magnetic field.

19. The method of claim 18, further comprising resisting a shear force exerted on one of the ring or base when the button is within the aperture.

20. The method of claim 18, wherein:
the ring contains a ring magnet;
the button contains a button magnet; and
the ring magnet and button magnet cooperate to magnetically attract the button to the ring.
